(19) United States
(12) Patent Application Publication
(10) Pub. No.: US 2011/0051209 A1
(43) Pub. Date: Mar. 3, 2011

(54) BEAM IRRADIATION APPARATUS AND LASER RADAR

(75) Inventors: Masato Yamada, Inuyama-City (JP); Takaaki Morimoto, Anapachi-Gun (JP); Yoichiro Goto, Gifu-City (JP)

(73) Assignee: SANYO Electric Co., Ltd., Moriguchi-shi (JP)

(21) Appl. No.: 12/869,312

(22) Filed: Aug. 26, 2010

(30) Foreign Application Priority Data
Aug. 27, 2009 (JP) 2009-197471

(51) Int. Cl. G02B 26/10

(52) U.S. Cl. 359/197.1

(57) ABSTRACT

A beam irradiation apparatus includes a light source which outputs a laser beam, a convergent lens into which the laser beam output from the light source is entered, and a scanning portion which makes the laser beam transmitted through the convergent lens scan on a target region. In the beam irradiation apparatus, the laser light source is arranged such that a pn junction surface of a laser chip is parallel with the vertical direction. Length of the laser beam in the vertical direction on the target region is set by length of a light emitting portion of the laser light source in the vertical direction. Further, a wavefront aberration of the convergent lens with respect to the laser beam is set to be 0.15 λrms or less.

This application claims priority under 35 U.S.C. Section 119 of Japanese Patent Application No. 2009-197471 filed Aug. 27, 2009, entitled “BEAM IRRADIATION APPARATUS AND LASER RADAR”. The disclosure of the above applications is incorporated herein by reference.

### BACKGROUND OF THE INVENTION

1. Field of the Invention

The present invention relates to a beam irradiation apparatus which irradiates a target region with light and a laser radar on which the beam irradiation apparatus is mounted.

2. Related Art

In recent years, a laser radar is mounted on a household automobile or the like in order to enhance safety while driving. In general, the laser radar makes a laser beam scan within a target region and detects presence/absence of an obstacle at each scanning position based on presence/absence of reflected light from each scanning position. Further, a distance to the obstacle is detected based on a time needed from an irradiation timing of a laser beam at each scanning position to a reception timing of reflected light.

A beam irradiation apparatus for making a laser beam scan on a target region is incorporated into the laser radar. In a case where the laser radar is mounted on an automobile, detection accuracy in the horizontal direction is improved in comparison with that in the vertical direction. Therefore, the beam irradiation apparatus mounted on the laser radar of such type irradiates the target region with a beam having a shape which is longer in the vertical direction and narrower in the horizontal direction.

When a laser diode is used as a light source of the beam irradiation apparatus, a divergence angle of an output laser beam is large in the direction perpendicular to a pn junction surface (hereinafter, referred to “short side direction”) and is small in the direction parallel with the pn junction surface (hereinafter, referred to “longitudinal direction”). Therefore, when the laser diode is used as the light source of the beam irradiation apparatus, a configuration for adjusting a shape of a beam on the target region to a desired shape is needed. In this case, a beam shaping lens such as a cylindrical lens may be used in addition to a convergent lens.

However, if the beam shaping lens such as the cylindrical lens is needed in addition to the convergent lens as described above, a problem that a shape of the beam on the target region is distorted due to an aberration caused by the cylindrical lens or the like may arise. Further, if distortion is caused in a beam profile on the target region, there is a risk that an accuracy of detecting an obstacle is deteriorated.

### SUMMARY OF THE INVENTION

A first aspect of the invention relates to a beam irradiation apparatus. The beam irradiation apparatus according to the first aspect of the invention includes a light source which outputs a laser beam, a convergent lens into which the laser beam output from the light source is entered, and a scanning portion which makes the laser beam transmitted through the convergent lens scan on a target region. In the beam irradiation apparatus, the laser light source is arranged such that a pn junction surface of a laser chip is parallel with the vertical direction. Length of the laser beam in the vertical direction on the target region is set by length of a light emitting portion of the laser light source in the direction parallel with the vertical direction. Further, a wavefront aberration of the convergent lens with respect to the laser beam is set to be 0.15 λrms or less.

A second aspect of the invention relates to a laser radar. The laser radar according to the second aspect of the invention includes the beam irradiation apparatus according to the first aspect and a light reception portion which receives light from the target region.

### BRIEF DESCRIPTION OF THE DRAWINGS

The above-described and other objects and novel characteristics of the invention are made obvious more perfectly by reading the following description of embodiment and the following accompanying drawings.

FIGS. 1A and 1B are views for explaining a method of configuring a laser light source according to the embodiment.

FIG. 1C is a view illustrating a scanning of a laser beam on a target region.

FIGS. 2A and 2B are diagrams for explaining a method of configuring a convergent lens according to the embodiment.

FIGS. 3A and 3B are diagrams for explaining a method of configuring the convergent lens according to the embodiment.

FIGS. 4A and 4B are diagrams for explaining a method of configuring the convergent lens according to the embodiment.

FIG. 5 is an exploded perspective view illustrating a configuration of a mirror actuator according to the embodiment.

FIGS. 6A and 6B are perspective views illustrating a configuration of the mirror actuator according to the embodiment.

FIG. 7A is a view illustrating a configuration of an optical system of a beam irradiation apparatus according to the embodiment. FIGS. 7B and 7C are views illustrating an arrangement of a laser chip of the beam irradiation apparatus according to the embodiment.

FIGS. 8A and 8B are views illustrating a configuration of the optical system of the beam irradiation apparatus according to the embodiment.

FIG. 9 is a diagram illustrating a configuration of a laser radar according to the embodiment.

It is to be noted that the drawings are exclusively intended to explain the invention only and are not intended to limit a range of the invention.

### DESCRIPTION OF PREFERRED EMBODIMENTS

Hereinafter, an embodiment of the invention will be described with reference to drawings. Note that a beam irradiation apparatus according to the invention is mounted on a laser radar for an automobile.

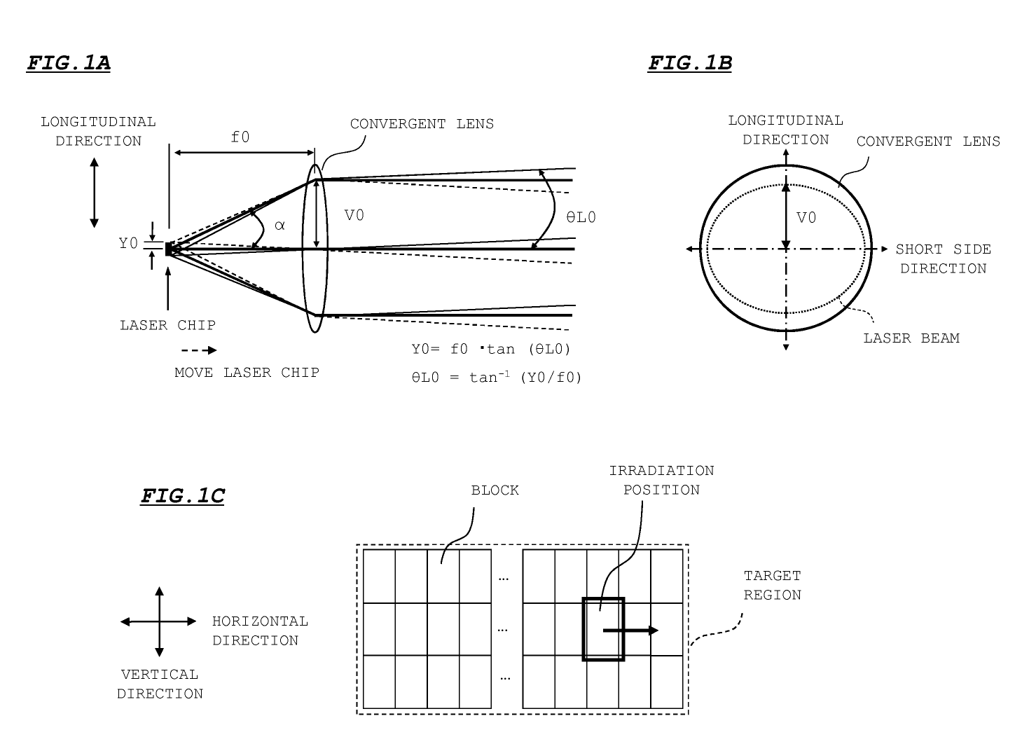

FIGS. 1A and 1B are views for explaining a method of configuring a laser light source in the beam irradiation apparatus. In FIGS. 1A and 1B, a convergent lens is a convex lens having a predetermined focal distance. A lens surface of the convergent lens has a rotational symmetrical shape about an optical axis.

If a laser chip of the laser light source (laser diode) is arranged at a focal position of the convergent lens as shown in FIG. 1A, the following relationship is established among a divergence angle θL0 of a laser beam in the longitudinal direction (the direction parallel with a pn junction surface) after the laser beam transmits through the convergent lens, a half value Y0 of length of the laser chip in the longitudinal direction (length of a light emitting portion) and a focal distance f0 of the convergent lens. It is to be noted that the following relational expressions are satisfied when the divergence angle θL0 is a value close to zero.

Y0=f0·tan(θL0) (1)

θL0=tan⁻¹(Y0/f0) (2)

In this case, the divergence angle of the laser beam in the short side direction (the direction perpendicular to a pn junction surface) after the laser beam transmits through the convergent lens is zero. That is to say, the laser beam which is output so as to be spread in the short side direction transmits through the convergent lens, and then, travels parallel with the optical axis. In this case, the laser beam enters into the lens as shown in FIG. 1B, for example.

FIG. 1C is a view illustrating a scanning form of the laser beam on a target region.

Irradiation blocks of three stages in the vertical direction are set as the target region. Each block has an elongated shape in the vertical direction. The laser beam output from the beam irradiation apparatus sequentially scans each block on the target region row by row in the horizontal direction from left to right, for example. As shown in FIG. 1C, the irradiation region of the laser beam on the target region is set to be slightly larger than each block. The beam irradiation apparatus pulse-emits the laser beam at a timing where a scanning position corresponds to a position of each block.

With the above expressions (1) and (2), if the laser chip is arranged on the focal position of the convergent lens, the laser beam has a predetermined divergence angle θL0 in the longitudinal direction. Therefore, the laser chip is desired to be arranged such that the longitudinal direction is in parallel with the vertical direction in order to make the laser beam on the target region have an elongated shape in the vertical direction as shown in FIG. 1C. With this, the length of the laser beam in the vertical direction on the target region can be set to a desired length by adjusting the half value Y0 of the length of the laser chip in the longitudinal direction (vertical direction) or the focal distance f0 of the lens.

In this case, a width of the laser beam in the horizontal direction on the target region can be adjusted by moving the position of the laser chip from the position as shown in FIG. 1A toward the convergent lens as shown by a dashed-line arrow as shown in FIG. 1A. Here, the position as shown in FIG. 1A indicates a position of the focal distance f0 of the convergent lens. That is to say, if the position of the laser chip is made close to the convergent lens from the focal position of the convergent lens, the divergence angle θs0 of the laser beam in the short side direction (horizontal direction) after the laser beam transmits through the convergent lens can be obtained by the following expression.

θAs0=λ/(πω) (3)

In the expression, λ indicates a wavelength of the laser beam and ω indicates a radius of beam waist at a virtual image position. Note that the expression is satisfied when the width of the laser chip in the short side direction is small and the laser chip is regarded as a point light source.

With the above expression (3), the width of the laser light in the horizontal direction on the target region can be set to a desired width by making the position of the laser chip close to the convergent lens from the focal position of the convergent lens and adjusting the divergence angle θs0 in the short side direction (horizontal direction).

In this case, the divergence angle θs0 can be set to a desired value by slightly moving the position of the laser chip from the position of the focal distance of the convergent lens. Therefore, the divergence angle θL0 of the laser beam in the longitudinal direction (vertical direction) as shown in FIG. 1A is not so different from that in a case where the laser chip is at the position of the focal distance even when the position of the laser chip is moved in such a manner. Accordingly, the length of the laser beam in the vertical direction on the target region can be kept to be a desired length even if the position of the laser chip is moved in order to adjust the divergence angle θs0 in the short side direction (horizontal direction).

The shape of the laser beam on the target region can be made an elongated shape in the vertical direction by arranging the laser chip such that the longitudinal direction is in parallel with the vertical direction as described above. Further, with the above expressions (1) and (2), the length of the laser beam in the vertical direction on the target region can be set to a desired length by adjusting the half value Y0 of the length of the laser chip in the longitudinal direction (vertical direction) or the focal distance f0 of the lens. The length of the laser beam in the horizontal direction on the target region can be adjusted to a desired length by making the position of the laser chip close to the convergent lens from the focal position of the convergent lens.

In the embodiment, the half value Y0 of the length of the laser chip in the longitudinal direction (vertical direction) or the focal distance f0 of the lens is adjusted and the position of the laser chip with respect to the focal position of the convergent lens is adjusted such that a size of the irradiation region of the laser beam on the target region is a predetermined size. In the embodiment, since a shape of the beam can be set by a configuration and an arrangement of the laser chip in such a manner, a lens for shaping the beam is not needed. Therefore, a beam profile of the laser beam on the target region is not deteriorated due to an aberration caused by the beam shaping lens. Further, the laser beam output from the laser chip is entered into the convergent lens not through an aperture for shaping the beam. Therefore, a beam profile of the laser beam on the target region is not also deteriorated due to diffraction by the aperture.

Further, in the embodiment, the beam profile of the laser beam on the target region is further stabilized by setting characteristics of the convergent lens as follows.

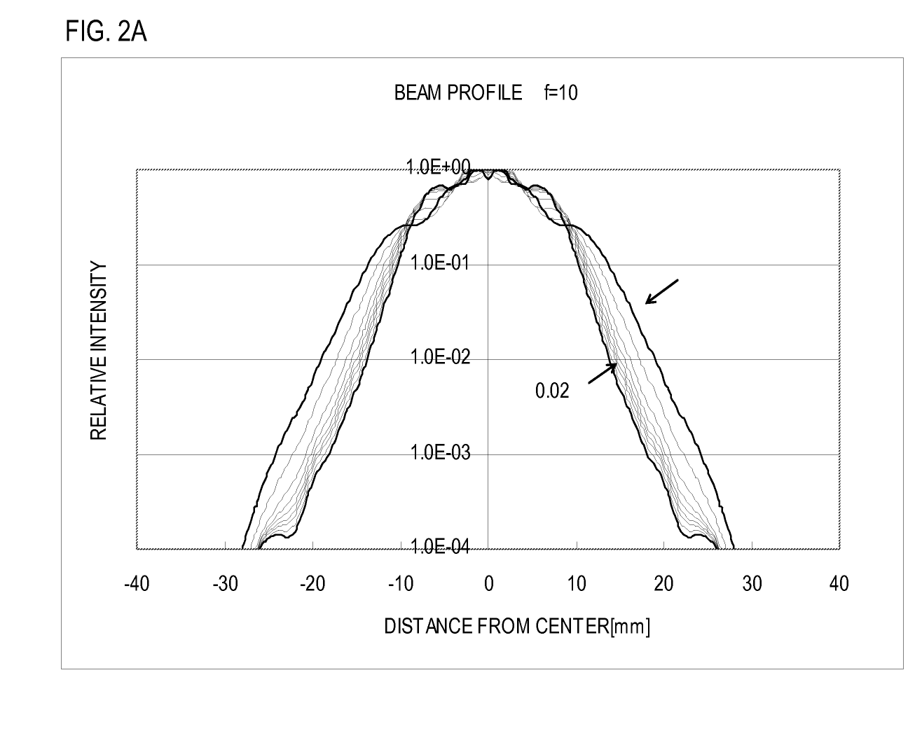

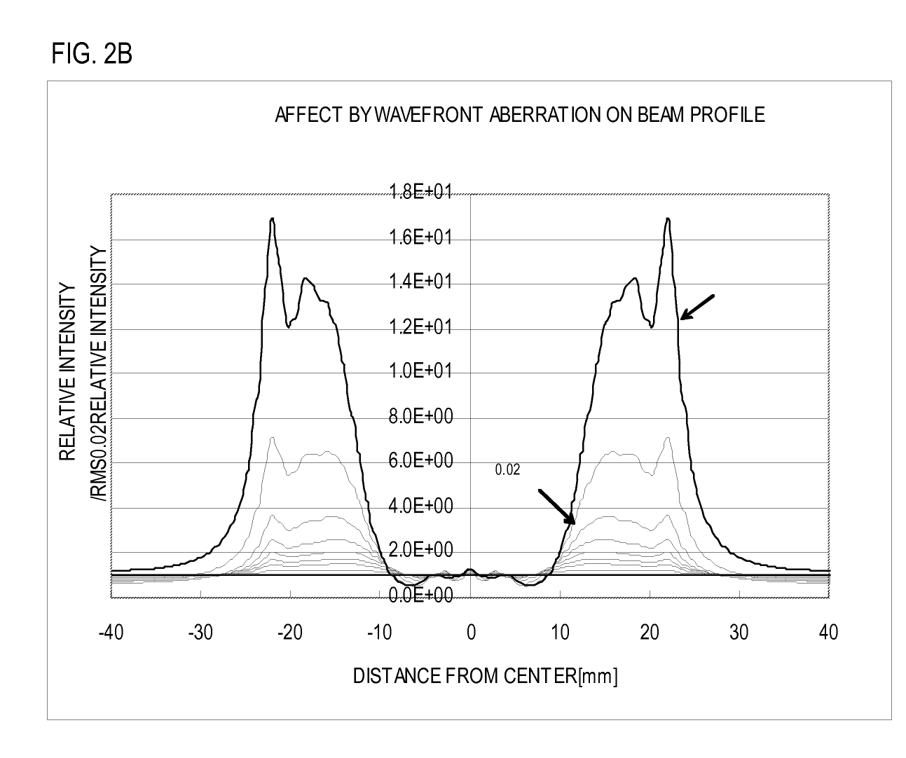

FIG. 2A through FIG. 4B are diagrams illustrating results of simulations made by the inventors in order to set the characteristics of the convergent lens. Conditions of the simulations are set as follows.

<Condition 1>
(a) Convergent lens

| A. | Lens specification | Both-side aspherical single lens |
|---|---|---|
| B. | Focal Distance | 10 mm |
| C. | Opening Number (NA) | 0.35 |

(b) Laser chip

| | | |
|---|---|---|
| D. | Wavelength of | 905 mm |
| | output light | |
| E. | Light emitting portion | Short side direction thereof is |
| | | regarded as point light source |
| F. | Laser divergence angle | 40 degree horizontal, 14 degree |
| | (1/e2 TOTAL ANGLE) | vertical |

(c) Divergence angle and position of laser chip

| | | |
|---|---|---|
| G. | Divergence angle and | 0.1 degree in short side direction |
| | position of laser chip | |
| H. | Position of laser chip | Position at which divergence angle |
| | | in short side direction is 0.1 degree |

<Condition 2>
(a) Convergent lens

| A. | Lens specification | Both-side aspherical single lens |
|---|---|---|
| B. | Focal Distance | 16 mm |
| C. | Opening Number (NA) | 0.35 |

(b) Laser chip

| | | |
|---|---|---|
| D. | Wavelength of | 905 mm |
| | output light | |
| E. | Light emitting portion | Short side direction thereof is |
| | | regarded as point light source |
| F. | Laser divergence angle | 40 degree horizontal, 14 degree |
| | (1/e2 TOTAL ANGLE) | vertical |

(c) Divergence angle and position of laser chip

| | | |
|---|---|---|
| G. | Divergence angle and | 0.1 degree in short side direction |
| | position of laser chip | |
| H. | Position of laser chip | Position at which divergence angle |
| | | in short side direction is 0.1 degree |

A focal distance of the convergent lens as shown in the above condition 2 indicates a focal distance which is needed to take a laser beam from the laser chip into the convergent lens having a standard size (lens effective diameter=about 13 mm) in current beam irradiation apparatuses for automobiles. That is to say, if the focal distance is 16 mm or less, the convergent lens can take all of the laser beam having the divergence angle as shown in F in the above condition 2. On the other hand, if the focal distance is larger than 16 mm, the convergent lens cannot take a part of the laser beam having the above divergence angle.

It is to be noted that the simulations are performed on the assumption that other optical devices such as a beam shaping lens and an aperture are not arranged between the laser chip and the convergent lens at all as shown in FIG. 1A.

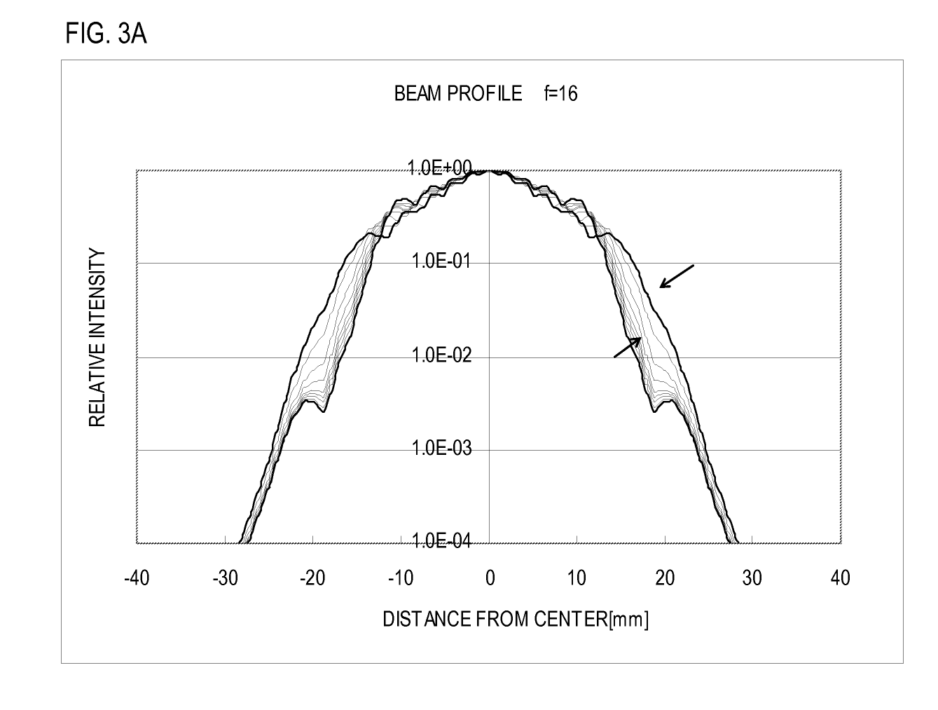

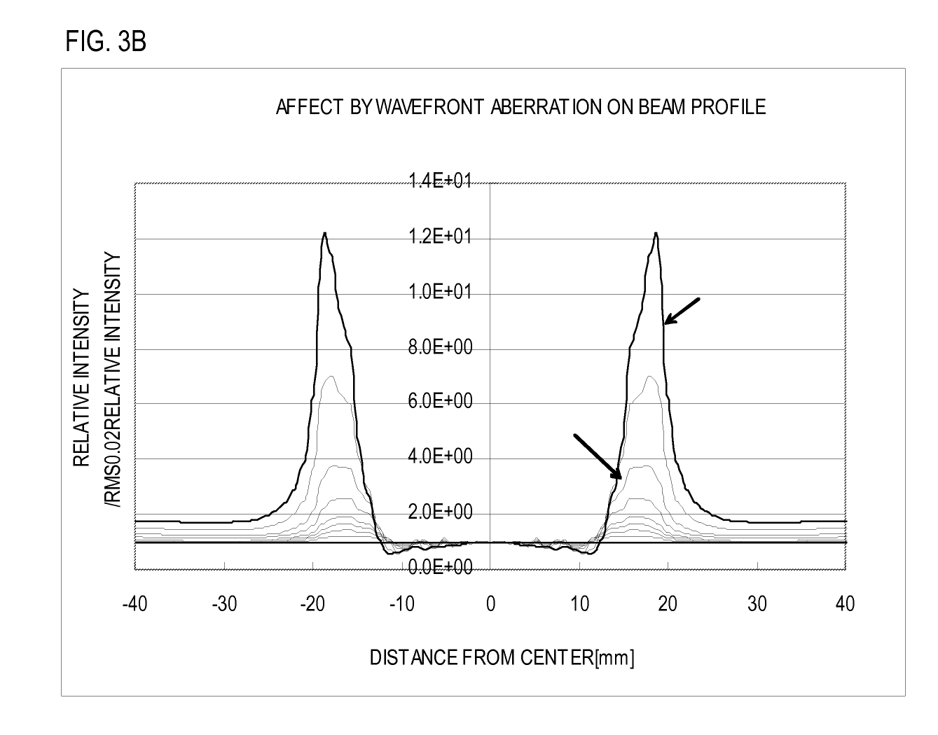

FIGS. 2A and 3A are results of the simulations performed as follows. That is, a beam profile in the short side direction when the laser beam is output from the laser chip in each of the optical systems configured in accordance with each of the above condition 1 and condition 2 is obtained at a position which is 10 m ahead of the convergent lens. In FIGS. 2A and 3A, a horizontal axis indicates a distance from the center of the beam and a vertical axis indicates an intensity of the laser beam at each distance. Each result of the simulations is normalized by setting an intensity at the center of the beam to 1. Further, in each of FIGS. 2A and 3A, results of the simulations obtained when wavefront aberrations of the convergent lens are changed at nine stages.

Here, the wavefront aberrations of the convergent lens set in the simulations are 0.4 (λrms), 0.3 (λrms), 0.2 (λrms), 0.14 (λrms), 0.1 (λrms), 0.08 (λrms), 0.06 (λrms), 0.04 (λrms), and 0.02 (λrms). In each of FIGS. 2A and 3A, an outermost waveform is a simulation result when the wavefront aberration is 0.4 (λrms), and an innermost waveform is a simulation result when the wavefront aberration is 0.02 (λrms). The wavefront aberrations of the inner side waveforms become smaller.

In each simulation, the beam profiles are obtained till a weak intensity at which a relative intensity is 1.0×10⁻⁴. When the beam irradiation apparatus is mounted on the laser radar for an automobile, high detection accuracy is needed. In this case, the beam having such weak intensity may affect the detection accuracy.

In the laser radar, the target region is desired to be irradiated with a laser beam having clear contour without blurring on the periphery of the beam. Accordingly, in each of the simulation results in FIGS. 2A and 3A, the beam profile is desired to be formed into a spike form as sharp as possible such that skirt portions are not spread in the left-right directions. In each of the simulation results, the wavefront aberration of 0.02 (λrms) is considered to be substantially aberration-free. The beam profile in this case has a sharp spike form such that skirt portions are not spread. As the wavefront aberration of the convergent lens is larger, the beam profile has a gentler mountain-like shape such that skirt portions are spread. That is to say, as the wavefront aberration of the convergent lens is larger, blurring on the periphery of the laser beam irradiated onto the target region is larger.

FIGS. 2B and 3B are simulation results obtained by dividing each of the intensities of the beam profiles having the wavefront aberrations as shown in FIGS. 2A and 3A by the intensity of the beam profile having a wavefront aberration of 0.02 (λrms) as an ideal waveform. As is obvious from these simulation results, as the wavefront aberration of the convergent lens is larger, the beam profile has a gentler mountain-like waveform such that skirt portions are spread. The degree of spreading of the beam profile, that is, the degree of blurring of the laser beam on the target region is recognized from the size of the mountain in each waveform. As the mountain is larger, the laser beam can be evaluated to be blurred on the target region.

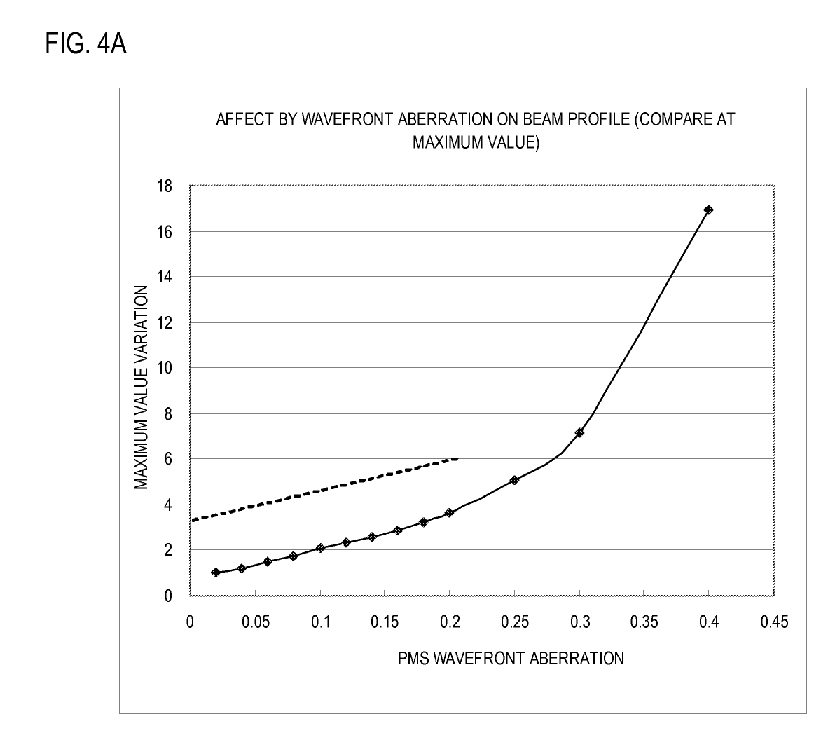

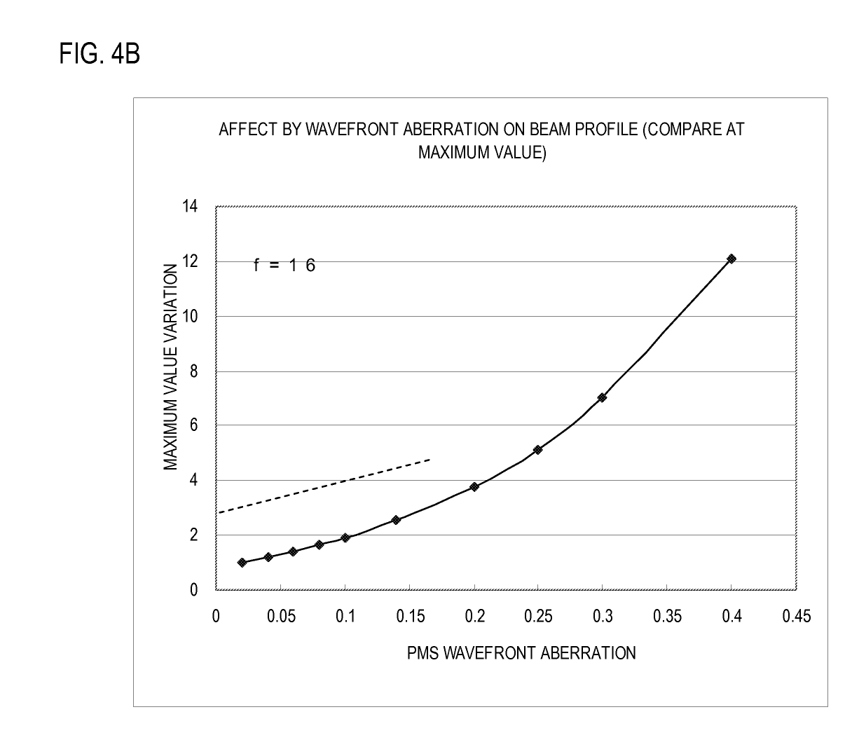

FIGS. 4A and 4B are graphs obtained by plotting the heights of the mountains (maximum value in the vertical axis) in FIGS. 2B and 3B for each wavefront aberration. In FIGS. 4A and 4B, a straight line is added with dashed line for convenience of explanation.

Referring to FIG. 4A, when the focal distance of the convergent lens is set to 10 mm, maximum values of the waveforms in FIG. 2B change in a linear fashion until the wavefront aberration reaches to around 0.18 (λrms) and the maximum values of the waveforms in FIG. 2B change so as to be larger in an exponential fashion after the wavefront aberration is beyond around 0.18 (λrms).

Referring to FIG. 4B, when the focal distance of the convergent lens is set to 16 mm, maximum values of the waveforms in FIG. 3B change in a linear fashion until the wavefront aberration reaches to around 0.15 (λrms) and the maximum values of the waveforms in FIG. 3B change so as to be larger in an exponential fashion after the wavefront aberration is beyond around 0.15 (λrms).

The wavefront aberration of the convergent lens thus changes due to arrangement errors with respect to the optical system, change in temperature of the convergent lens, or the like. Therefore, the wavefront aberration of the convergent lens is desired to be set in a range where the maximum value of the waveform as shown in FIG. 2B does not largely change even when the wavefront aberration of the convergent lens changes due to arrangement errors, change in temperature of the convergent lens, or the like.

From this viewpoint, when the focal distance of the convergent lens is 10 mm, the wavefront aberration of the convergent lens is desired to be set to a range of 0.18 (λrms) or less as is seen from FIG. 4A. By setting in this manner, even when the wavefront aberration changes due to arrangement errors with respect to the optical system, change in temperature of the convergent lens, or the like, the maximum value of the waveform as shown in FIG. 2B does not largely change and the laser beam on the target region can be prevented from being significantly blurred. Further, if the wavefront aberration of the convergent lens is set to a range of 0.18 (λrms) or less, the maximum value of the waveform as shown in FIG. 2B is 3 or less. Therefore, the target region can be irradiated with a laser beam having clear contour in a state where blurring on the periphery of the beam is suppressed.

Accordingly, when the focal distance of the convergent lens is 10 mm, the following effects can be obtained by setting the wavefront aberration of the convergent lens to a range of 0.18 (λrms) or less. That is, the target region can be irradiated with a laser beam having clear contour in a state where blurring on the periphery of the beam is suppressed and the laser beam on the target region can be prevented from being significantly blurred even if the wavefront aberration of the convergent lens changes due to arrangement errors of the convergent lens with respect to the optical system, change in temperature of the convergent lens, or the like.

From the same viewpoint, when the focal distance of the convergent lens is 16 mm, the wavefront aberration of the convergent lens is desired to be set to a range of 0.15 (λrms) or less as is seen from FIG. 4B. By setting in this manner, even when the wavefront aberration changes due to arrangement errors with respect to the optical system, change in temperature of the convergent lens, or the like, the maximum value of the waveform shown in FIG. 3B does not largely change and the laser beam on the target region can be prevented from being significantly blurred. Further, if the wavefront aberration of the convergent lens is set to a range of 0.15 (λrms) or less, the maximum value of the waveform as shown in FIG. 3B is 3 or less. Therefore, the target region can be irradiated with a laser beam having clear contour in a state where blurring on the periphery of the beam is suppressed.

Accordingly, when the focal distance of the convergent lens is 16 mm, the following effects can be obtained by setting the wavefront aberration of the convergent lens to a range of 0.15 (λrms) or less. That is, the target region can be irradiated with a laser beam having clear contour in a state where blurring on the periphery of the beam is suppressed and the laser beam on the target region can be prevented from being significantly blurred even if the wavefront aberration of the convergent lens changes due to arrangement errors of the convergent lens with respect to the optical system, change in temperature of the convergent lens, or the like.

From the results of the above two studies, when the focal distance of the convergent lens is 16 mm or less so as to take all of the laser beam from the laser chip, the wavefront aberration of the convergent lens is desired to be set be 0.15 (λrms) or less. Therefore, the target region can be irradiated with a laser beam having high intensity and clear contour and the laser beam on the target region can be prevented from being significantly blurred. Accordingly, an obstacle on the target region can be stably detected with high accuracy while enhancing safety. It is to be noted that the same tendency as the above configuration can be obtained if the wavelength of the laser beam is set to around 900 nm±100 nm.

### Specific Configuration Example

Hereinafter, a specific configuration example of the beam irradiation apparatus according to the embodiment is described.

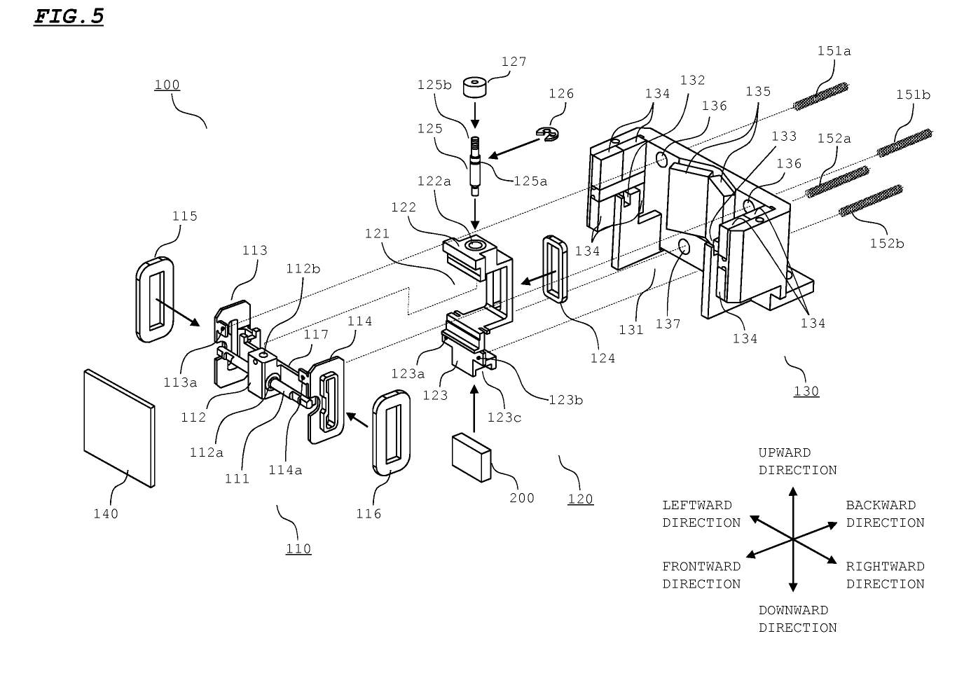

At first, a configuration of a mirror actuator 100 for making a laser beam scan on a target region is described with reference to FIG. 5.

In FIG. 5, a reference numeral 110 corresponds to a tilt unit. The tilt unit 110 includes a supporting shaft 111, a bearing portion 112, coil supporting plates 113, 114, coils 115, 116 and a connecting portion 117. The bearing portion 112 is rotatably attached to the supporting shaft 111. The coil supporting plates 113, 114 are arranged at positions so as to be symmetric with respect to the bearing portion 112. The coils 115, 116 are attached to the coil supporting plates 113, 114, respectively. The connecting portion 117 connects the bearing portion 112 and the coil supporting plates 113, 114.

A shaft hole 112a penetrating through in the left-right direction is provided on the bearing portion 112. The supporting shaft 111 is put through the shaft hole 112a. The bearing portion 112 is attached to a center portion of the supporting shaft 111. Further, a hole 112b is provided on an upper face of the bearing portion 112.

Flange portions projecting in the left-right direction are formed on the upper side faces of the coil supporting plates 113, 114. Holding holes 113a, 114a are provided on the respective flange portions. The holding holes 113a, 114a are provided at positions so as to be symmetric with respect to the bearing portion 112. Positions of the holding holes 113a, 114a in the up-down direction and front-rear direction are the same as each other.

Coils 115, 116 each of which is wound into a square form are attached to the coil supporting plates 113, 114, respectively. An output terminal of the coil 115 is connected to an input terminal of the coil 116 with a signal line (not shown).

A reference numeral 120 corresponds to a pan unit. The pan unit 120 includes a recess 121, a bearing portion 122, a reception portion 123, a coil 124, a supporting shaft 125, an E ring 126 and a balancer 127. The recess 121 accommodates the tilt unit 110. The bearing portion 122 is continuously connected to an upper portion of the recess 121. The reception portion 123 is continuously connected to a lower portion of the recess 121. The coil 124 is attached to a rear face of the recess 121.

A shaft hole 122a penetrating through in the up-down direction is provided on the bearing portion 122. As described later, the supporting shaft 125 is put through the shaft hole 122a in the up-down direction when the tilt unit 110 and the pan unit 120 are assembled. As shown in FIG. 5, a groove 125a with which the E ring 126 is fastened is formed on the supporting shaft 125. A thread groove 125b to which the balancer 127 is attached is formed on an upper portion of the supporting shaft 125.

Holding holes 123a, 123b are provided on the reception portion 123. The holding holes 123a, 123b are provided at positions so as to be symmetric with respect to the supporting shaft 125. Positions of the holding holes 123a, 123b in the up-down direction and the front-rear direction are the same as each other. A recess 123c is formed on a lower edge of the reception portion 123. A gap of the recess 123c in the front-rear direction has substantially the same dimension as the thickness of a transparent body 200. An upper portion of the transparent body 200 is attached to the recess 123c.

A coil attachment portion (not shown) is formed on a rear face of the pan unit 120. A coil 124 which is wound into a square form is attached to the coil attachment portion.

A reference numeral 130 corresponds to a magnet unit. The magnet unit 130 includes a recess 131, grooves 132, 133, eight magnets 134 and two magnets 135. The recess 131 accommodates the pan unit 120. The grooves 132, 133 engage with both edges of the supporting shaft 111. The eight magnets 134 apply magnetic fields to the coils 115, 116. The two magnets 135 apply a magnetic field to the coil 124.

The eight magnets 134 are attached to left and right inner side faces of the recess 131 so as to be divided into two stages of the upper side and the lower side. Further, the two magnets 135 are attached to the inner side faces of the recess 131 so as to be inclined in the front-rear direction as shown in FIG. 5. Further, holes 136, 137 to which power supply springs 151a, 151b, 152a, 152b are inserted are formed on the recess 131.

When the mirror actuator 100 is assembled, the tilt unit 110 is assembled, at first. That is to say, the supporting shaft 111 is attached to the shaft hole 112a and the coils 115, 116 are attached to the coil supporting plates 113, 114, respectively.

Thereafter, the assembled tilt unit 110 is accommodated in the recess 121 of the pan unit 120. Then, the supporting shaft 125 is inserted from the upper side in a state where the hole 112b of the tilt unit 110 and the shaft hole 122a of the pan unit 120 are matched with each other in the up-down direction. A lower edge of the supporting shaft 125 is fixed to the hole 112b. Then, the E ring 126 is fastened to the groove 125a so that the supporting shaft 125 does not move downwardly from a position at which the E ring 126 is fastened with respect to the pan unit 120. Thus, the pan unit 120 is rotatably supported with respect to the tilt unit 110 by the supporting shaft 125.

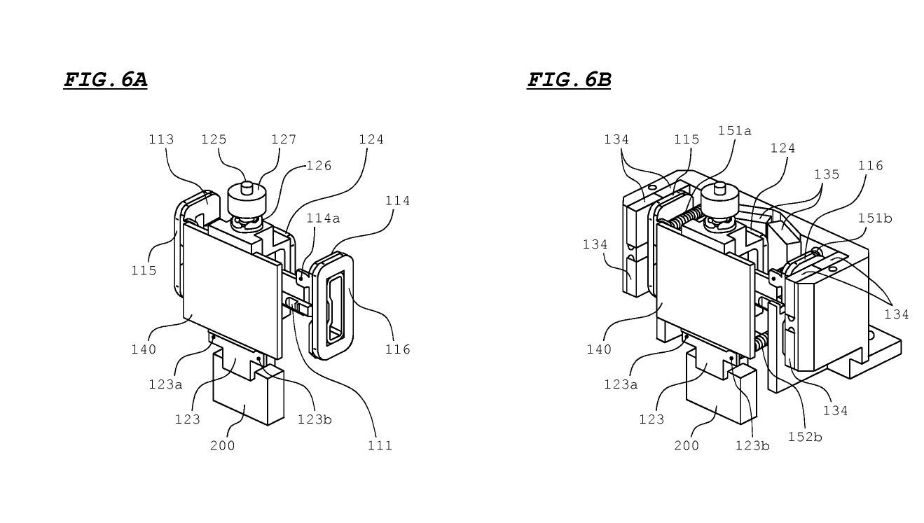

Thereafter, the balancer 127 is fastened to the thread groove 125b of the supporting shaft 125. Further, the transparent body 200 is attached to the recess 123c. A mirror 140 is attached to a front face of the pan unit 120. Thus, the tilt unit 110, the pan unit 120 and the mirror 140 are completely assembled as shown in FIG. 6A.

Note that the balancer 127 is a portion for adjusting the constituent components of the mirror actuator 100 which rotates about the supporting shaft 111 so as to rotate in a balanced manner when the constituent components of the mirror actuator 100 rotates about the supporting shaft 111. The balance of such rotation is adjusted by weight of the balancer 127. In addition, a position of the balancer 127 in the up-down direction is fine-adjusted by the thread groove 125b of the supporting shaft 125 so that the balance of the rotation is adjusted.

Thereafter, a configured body as shown in FIG. 6A is attached to the magnet unit 130.

Returning to FIG. 5, both edges of the supporting shaft 111 are fixed to the grooves 132, 133 of the magnet unit 130, from the upper side. Engagement portions which engage with the grooves 132, 133, are formed on the both edges of the supporting shaft 111. When these engagement portions are fitted into the grooves 132, 133, the supporting shaft 111 is fixed to the grooves 132, 133 without rotating.

Subsequently, the power supply springs 151a, 151b, 152a, 152b are put through the holes 136, 137 from the rear face side of the recess 131. In this case, distal edges of the power supply springs 151a, 151b are locked by the holding holes 113a, 114a of the tilt unit 110. Further, the distal edges of the locked power supply springs 151a, 151b are electrically connected to the input terminal of the coil 115 and the output terminal of the coil 116, respectively, with solders or the like. Rear edges of the power supply springs 151a, 151b are locked by the holding holes provided on the rear face side of the magnet unit 130.

On the other hand, distal edges of the power supply springs 152a, 152b are locked by the holding holes 123a, 123b of the pan unit 120, respectively. Further, the distal edges of the locked power supply springs 152a, 152b are electrically connected to an input terminal and an output terminal of the coil 124, respectively, with solders or the like. Rear edges of the power supply springs 152a, 152b are locked by the holding holes provided on the rear face side of the magnet unit 130.

When an interconnect substrate is arranged on the rear face of the magnet unit 130, the rear edges of the power supply springs 151a, 151b, 152a, 152b are locked to holding holes formed on the interconnect substrate.

A beryllium copper or the like having small resistance value and excellent durability is used as materials of the power supply springs 151a, 151b, 152a, 152b. In the embodiment, a coil spring obtained by winding a wire rod having excellent conductivity into a coil form is used as each of the power supply springs 151a, 151b, 152a, 152b.

In such a manner, the mirror actuator 100 is completely assembled as shown in FIG. 6B. If the assembled mirror actuator 100 is arranged such that the up-down direction as shown in FIG. 5 is parallel with the vertical direction, the supporting shaft 111 and the supporting shaft 125 are parallel with the left-right direction and the up-down direction as shown in FIG. 5, respectively and the mirror 140 faces to the front side.

Lengths, spring coefficients, and the like of the power supply springs 151a, 151b, 152a, 152b are set such that the mirror 140 of the mirror actuator 100 after assembled faces to the front side. Further, the power supply springs 151a, 151b, 152a, 152b are set so as to have expanding and contracting allowances in a allowable range where the mirror 140 rotates after the mirror actuator 100 is assembled.

Referring to FIG. 5 and FIGS. 6A and 6B, when the pan unit 120 rotates about the supporting shaft 125 with respect to the tilt unit 110, the mirror 140 rotates in accompanied therewith. Further, when the tilt unit 110 rotates about the supporting shaft 111 with respect to the magnet unit 130, the pan unit 120 rotates in accompanied with the rotation of the tilt unit 110 and the mirror 140 rotates integrally with the pan unit 120. Thus, the mirror 140 is rotatably supported by the supporting shafts 111, 125 which are perpendicular to each other and rotates about the supporting shafts 111, 125 by applying currents to the coils 115, 116, 124. At this time, the transparent body 200 attached to the pan unit 120 rotates in accompanied with the rotation of the mirror 140.

In the assembled state as shown in FIG. 6B, the eight magnets 134 are arranged and polarities thereof are adjusted such that a rotational force about the supporting axis 111 is generated on the tilt unit 110 by applying currents to the coils 115, 116 through the power supply springs 151a, 151b. Accordingly, if currents are applied to the coils 115, 116, the tilt unit 110 rotates about the supporting axis 111 with electromagnetic driving forces generated on the coils 115, 116.

Further, in the assembled state as shown in FIG. 6B, the two magnets 135 are arranged and polarities thereof are adjusted such that a rotational force about the supporting axis 125 is generated on the pan unit 120 by applying current to the coil 124. Accordingly, if current is applied to the coil 124, the pan unit 120 rotates about the supporting axis 125 with an electromagnetic driving force generated on the coil 124. Further, the transparent body 200 rotates in accompanied therewith.

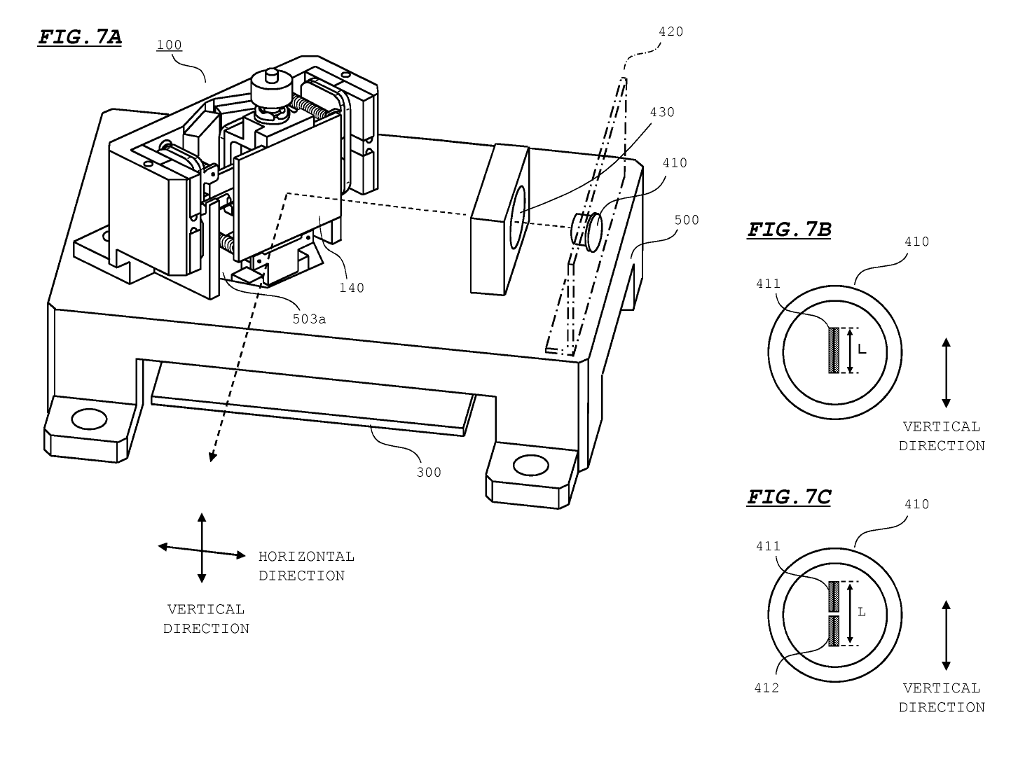

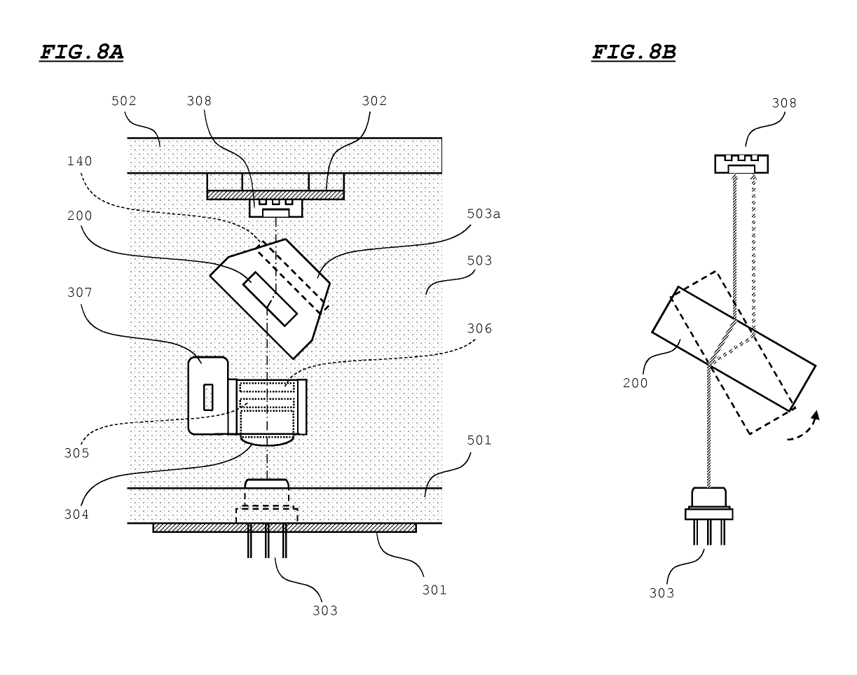

Next, the optical system of the beam irradiation apparatus is described with reference to FIGS. 7A, 7B, 8A and 8B.

A scanning optical system is described with reference to FIG. 7A, at first. In FIG. 7A, a reference numeral 500 corresponds to a base. In FIG. 7A, an upper face of the base 500 is horizontal. An opening 503a is formed on the base 500 at an arrangement position of the mirror actuator 100. The mirror actuator 100 is attached onto the base 500 such that the transparent body 200 is inserted to the opening 503a. The mirror actuator 100 is attached to the base 500 such that the up-down direction as shown in FIG. 5 corresponds to the vertical direction as shown in FIG. 7A.

A laser light source 410 and a convergent lens 430 are arranged on the upper face of the base 500. The laser light source 410 is attached to a substrate 420 for the laser light source. The substrate 420 is arranged on the upper face of the base 500. The laser light source 410 outputs a laser beam having a wavelength of about 900 nm. The convergent lens 430 is a convex lens having a predetermined focal distance. A lens surface of the convergent lens 430 has a rotationally symmetric shape about an optical axis.

The convergent lens 430 corresponds to the convergent lens as shown in FIGS. 1A and 1B. The focal distance and wavefront aberration of the convergent lens 430 are set to be in a range as described with reference to FIG. 2A through FIG. 4B. That is to say, a both-sided aspherical single lens of the standard size is used as the convergent lens 430. The focal distance of the convergent lens 430 is set to 16 mm or less and the wavefront aberration (ideal design value) thereof is set to 0.15 (λrms) or less.

As schematically showing in FIG. 7B, a laser chip 411 is arranged in a CAN of the laser light source 410. The laser light source 410 is arranged such that the longitudinal direction of the laser chip 411 is parallel with the vertical direction. Here, the length L of the laser chip 411 in the longitudinal direction is adjusted such that the laser beam has a desired shape on the target region as described with reference to FIGS. 1A and 1B. Further, the laser chip 411 is positioned to be slightly close to the convergent lens 430 from a position of the focal distance of the convergent lens 430 such that the laser beam transmitted through the convergent lens 430 spreads in the horizontal direction by a predetermined angle.

Note that although one laser chip 411 is arranged in the CAN of the laser light source 410 here, a plurality of laser chips may be arranged in the CAN so as to be aligned in the longitudinal direction. In this case, the entire length L of the light emitting portion composed of these laser chips in the vertical direction is adjusted such that the laser beam has a desired shape on the target region. With this configuration, an incident region of the laser beam onto the convergent lens 430 can be spread in the vertical direction. When the target region is irradiated with the laser beam, all of the laser chips emit lights simultaneously. FIG. 7C illustrates a configuration in which two laser chips 411, 412 are arranged in one CAN so as to be aligned in the longitudinal direction.

The laser beam (hereinafter, referred to as “scanning laser beam”) output from the laser light source 410 enters onto the convergent lens 430 not through other optical devices such as a beam shaping lens, an aperture or the like. The laser beam transmitted through the convergent lens 430 travels to the target region in a state where the laser beam is slightly diverged in the vertical direction and the horizontal direction such that the size of the laser beam becomes a predetermined size (for example, about 2 m long and about 1 m wide) on the target region. In this case, the target region is set to a position about 100 m ahead of the beam emitting port of the beam irradiation apparatus, for example.

The scanning laser beam transmitted through the convergent lens 430 enters into the mirror 140 of the mirror actuator 100 and is reflected by the mirror 140 toward the target region. The mirror 140 is biaxially driven by the mirror actuator 100 so that the scanning laser beam is scanned on the target region.

When the mirror 140 is at a neutral position, the mirror actuator 100 is arranged such that the scanning laser beam from the convergent lens 430 enters into a mirror surface of the mirror 140 at an incident angle of 45 degree in the horizontal direction. The expression “neutral position” indicates a position of the mirror 140 at which the mirror surface is parallel with the vertical direction and the scanning laser beam enters into the mirror surface at the incident angle of 45 degree with respect to the horizontal direction. The mirror 140 is positioned at the neutral position in a state where currents are not applied to the coils 115, 116, 124.

A circuit substrate 300 is arranged on a lower face of the base 500. Further, circuit substrates 301, 302 are arranged on a back face and a side face of the base 500, respectively.

FIG. 8A is a partial plan view when the base 500 is seen from the back face side. A servo optical system arranged on the back side of the base 500 and configurations peripheral to the servo optical system are illustrated in FIG. 8A.

As shown in FIG. 8A, walls 501, 502 are formed on back side edges of the base 500. A center portion between the walls 501, 502 corresponds to a flat face 503 which is lower than the walls 501, 502 by one step. An opening for attaching a laser diode 303 is formed on the wall 501. A circuit substrate 301 to which the laser diode 303 has been attached is attached to an outer face of the wall 501 in such a manner that the laser diode 303 is inserted into the opening. On the other hand, a circuit substrate 302 to which a PSD 308 has been attached is attached in the vicinity of the wall 502.

A condensing lens 304, an aperture 305, and a neutral density (ND) filter 306 are attached to the flat face 503 at the backside of the base 500 with an attachment 307. Further, the above opening 503a is formed on the flat face 503. The transparent body 200 attached to the mirror actuator 100 projects to the back side of the base 500 through the opening 503a. Here, when the mirror 140 of the mirror actuator 100 is at the neutral position, the transparent body 200 is positioned such that two flat faces are parallel with the vertical direction and are inclined at 45 degree with respect to the output light axis of the laser diode 303.

The laser beam (hereinafter, referred to as “servo beam”) output from the laser diode 303 is transmitted through the condensing lens 304. Then, a beam diameter thereof is restricted by the aperture 305. Further, the laser beam is extinguished by the ND filter 306. Then, the servo beam is entered into the transparent body 200 so as to be subjected to a refraction action by the transparent body 200. Thereafter, the servo beam transmitted through the transparent body 200 is received by the PSD 308 and a position detection signal in accordance with the light reception position is output from the PSD 308.

FIG. 8B is a view schematically illustrating a configuration in which a rotation position of the transparent body 200 is detected by the PSD 308. Note that only the transparent body 200, the laser diode 303 and the PSD 308 in FIG. 8A are illustrated in FIG. 8B for convenience of explanation.

The servo beam is refracted by the transparent body 200 arranged so as to be inclined with respect to the laser beam axis and received by the PSD 308. When the transparent body 200 is rotated as shown by a dashed line arrow, an optical path of the servo beam changes to a path as shown by a solid line from a path shown by the dotted line in FIG. 8B and a reception position of the servo beam on the PSD 308 changes. Therefore, a rotation position of the transparent body 200 can be detected by the reception position of the servo beam, which is detected by the PSD 308. The rotation position of the transparent body 200 corresponds to a scanning position of the scanning laser beam on the target region. Accordingly, the scanning position of the scanning laser beam on the target position can be detected based on a signal from the PSD 308.

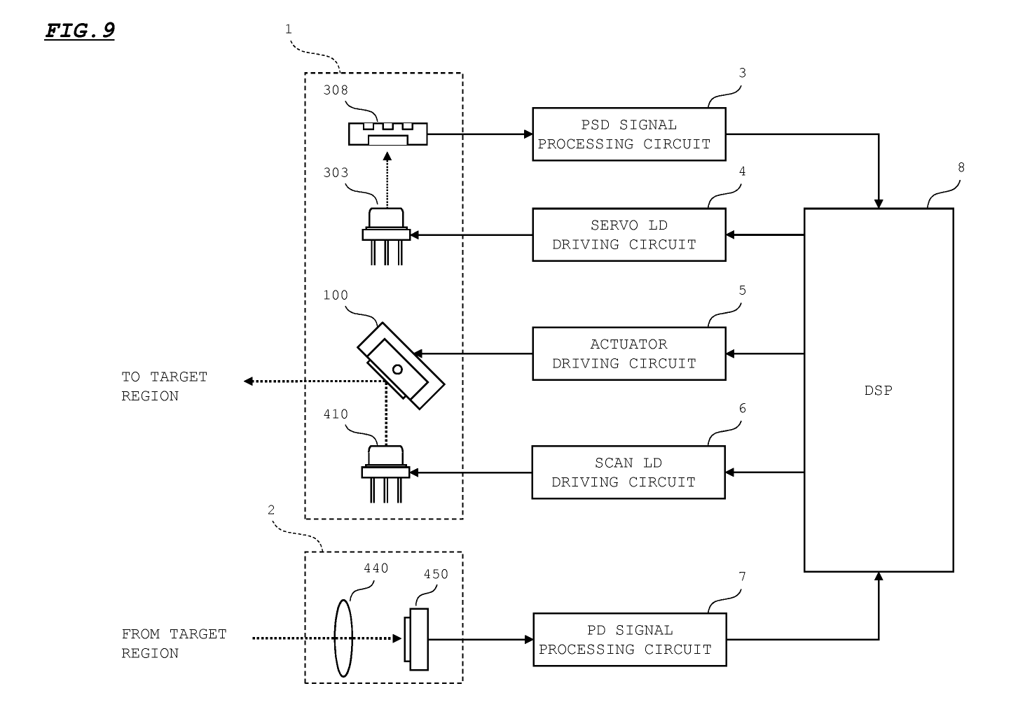

FIG. 9 is a view illustrating a configuration of a laser radar on which the beam irradiation apparatus having the above configuration is mounted. As shown in FIG. 9, the laser radar includes a beam irradiation apparatus 1 having the above configuration, a light reception portion 2, a PSD signal processing circuit 3, a servo LD driving circuit 4, an actuator driving circuit 5, a scan LD driving circuit 6, a PD signal processing circuit 7 and a DSP 8.

As the configurations in the beam irradiation apparatus 1, only the laser light source 410, the mirror actuator 100, the laser diode 303, and the PSD 308 are illustrated in FIG. 9 for convenience of explanation. The light reception portion 2 includes a condensing lens 440 which condenses a scanning laser beam reflected from the target region and a Photo Detector (PD) 450 which receives the condensed scanning laser beam.

The PSD signal processing circuit 3 generates a position detection signal from an output signal from the PSD 308 and outputs the generated signal to the DSP 8.

The servo LD driving circuit 4 supplies a driving signal to the laser diode 303 based on a signal from the DSP 8. To be more specific, when the beam irradiation apparatus 1 is operated, the servo beam having a constant output is output from the laser diode 303.

The actuator driving circuit 5 drives the mirror actuator 100 based on a signal from the DSP 8. To be more specific, a driving signal for making the scanning laser beam scan on the target region along a predetermined trajectory is supplied to the mirror actuator 100.

The scan LD driving circuit 6 supplies a driving signal to the laser light source 410 based on a signal from the DSP 8. To be more specific, the laser light source 410 pulse-emits at a timing where the scanning position of the scanning laser beam is at a predetermined position on the target region.

The PD signal processing circuit 7 amplifies and digitalizes a signal from the PD 450 to supply the obtained signal to the DSP 8.

The DSP 8 detects a scanning position of the scanning laser beam on the target region based on the position detection signal input from the PSD signal processing circuit 3 so as to control driving of the mirror actuator 100, driving of the laser light source 410, and the like. Further, the DSP 8 judges whether an obstacle is present on the irradiation position with the scanning laser on the target region based on the signal input from the PD signal processing circuit 7. At the same time, the DSP 8 measures a distance to the obstacle based on a time difference between an irradiation timing of the scanning laser beam output from the laser light source 410 and a light reception timing of the reflected light from the target region, which is received on the PD 450.

According to the embodiment, the laser light source is arranged such that the pn junction surface of the laser chip is parallel with the vertical direction so that the divergence angle of the laser beam in the vertical direction can be easily adjusted. In this case, the laser beam from the laser chip is entered into the convergent lens not through other optical devices such as a beam shaping lens, an aperture, or the like. Therefore, according to the embodiment, distortion due to the aberration caused by the beam shaping lens, diffraction caused by the aperture, or the like is not caused in the laser beam so that the target region can be appropriately irradiated with the laser beam.

Further, according to the embodiment, the wavefront aberration of the convergent lens is adjusted in a manner as described above with reference to FIG. 2A through FIG. 4B. Therefore, the target region can be irradiated with a laser beam having high intensity and clear contour. In addition, the laser beam on the target region can be prevented from being significantly blurred. Accordingly, an obstacle on the target region can be stably detected with high accuracy while enhancing safety.

As described above, according to the embodiment, the target region can be irradiated with a laser beam with a stable beam profile and the detection accuracy of an obstacle on the target region can be enhanced.

Although the embodiment of the invention has been described above, the invention is not limited to the above embodiment. Further, the embodiment of the invention can variously modified into modes other than the above embodiment.

For example, in the above embodiment and specific configuration example, the divergence angle of the laser beam in the horizontal direction is adjusting by making the position of the laser chip close to the convergent lens from the position of the focal distance of the convergent lens. However, the divergence angle of the laser beam in the horizontal direction may be adjusted by adjusting length of the light emitting portion in the short side direction as in the longitudinal direction. In this case, the length of the light emitting portion in the short side direction can be adjusted by stacking the laser chips in the short side direction.

Further, all or a part of the PSD signal processing circuit 3, the servo LD driving circuit 4, an actuator driving circuit 5 and the scan LD driving circuit 6 in the configuration shown in FIG. 9 may be included as configurations in the beam irradiation apparatus 1.

In addition, the embodiment of the invention can be appropriately modified in a range of claims.

What is claimed is:

1. A beam irradiation apparatus comprising:
a light source which outputs a laser beam;
a convergent lens into which the laser beam output from the light source is entered; and
a scanning portion which makes the laser beam transmitted through the convergent lens scan on a target region,
wherein the laser light source is arranged such that a pn junction surface of a laser chip is parallel with the vertical direction and length of the laser beam in the vertical direction on the target region is set by length of a light emitting portion of the laser light source in the direction parallel with the vertical direction, and
a wavefront aberration of the convergent lens with respect to the laser beam is set to be 0.15 λrms or less.

2. The beam irradiation apparatus according to claim 1,
wherein the laser chip is arranged in the vicinity of a focal position of the convergent lens.

3. The beam irradiation apparatus according to claim 2,
wherein when length of the laser beam in the vertical direction on the target region is assumed to be a predetermined length, in a case where a divergence angle of the laser beam after the laser beam passes through the convergent lens is θ, length of the light emitting portion in the vertical direction is set such that a half value y of the length of the light emitting portion in the vertical direction is y=f·tan θ.

4. The beam irradiation apparatus according to claim 1,
wherein the laser beam output from the light source is entered into the convergent lens not through an aperture.

5. A laser radar comprising:
a beam irradiation apparatus which irradiates a target region with a laser beam; and
a light reception portion which receives light from the target region,
wherein the beam irradiation apparatus includes;
a light source which outputs a laser beam;
a convergent lens into which the laser beam output from the light source is entered; and
a scanning portion which makes the laser beam transmitted through the convergent lens scan on a target region,
the laser light source is arranged such that a pn junction surface of a laser chip is parallel with the vertical direction and length of the laser beam in the vertical direction on the target region is set by length of a light emitting portion of the laser light source in the direction parallel with the vertical direction, and
a wavefront aberration of the convergent lens with respect to the laser beam is set to be 0.15 λrms or less.

6. The laser radar according to claim 5,
wherein the laser chip is arranged in the vicinity of a focal position of the convergent lens.

7. The laser radar according to claim 6,
wherein when length of the laser beam in the vertical direction on the target region is assumed to be a predetermined length, in a case where a divergence angle of the laser beam after the laser beam passes through the convergent lens is θ, length of the light emitting portion in the vertical direction is set such that a half value y of the length of the light emitting portion in the vertical direction is y=f·tan θ.

8. The laser radar according to claim 5,
wherein the laser beam output from the light source is entered into the convergent lens not through an aperture.
